(19) United States
(12) Patent Application Publication
(10) Pub. No.: US 2007/0040047 A1
(43) Pub. Date: Feb. 22, 2007

(54) Airbrush with external chucking nut

(76) Inventor: William Gentry Riley, Hickory, KY (US)

Correspondence Address: William Gentry Riley, 6200, ST, RT, 1241, Hickory, KY, 42051, US

(21) Appl. No.: 11/206,561

(22) Filed: Aug. 19, 2005

(51) Int. Cl. A62C 13/62

(52) U.S. Cl. 239/340; 239/408

(57) ABSTRACT

An airbrush includes a tubular handle having coaxially disposed therein an extended chucking nut threadably coupled at a forward end to the needle chuck of the airbrush and protruding externally from the rearward end of the tubular handle. Rotation of the external end of the chucking nut loosens or tightens the needle chuck, thereby supporting quick mounting and dismounting of the needle. Pulling rearward on the external end of the chucking nut pulls the needle rearward, beyond the maximum spray needle position, and thereby supports convenient flushing of the airbrush nozzle. Rotation of the tubular handle adjusts the position of the chucking nut relative to the airbrush body to offset the range of needle movement available through trigger action and thereby supports adjustment in the minimum spray or preset position of the needle.

### BACKGROUND OF THE INVENTION

An airbrush brings together a flow of paint and compressed air to produce a spray for application to a target surface. Control over the magnitude and character of the spray involves a needle tip moved, by trigger operation, longitudinally within the airbrush nozzle and by coordinated release of compressed air past the nozzle. Trigger operation both releases compressed air past the airbrush nozzle and moves the needle between a forward “preset” minimum spray position and a rearward maximum spray position. Typically, the needle is spring-biased forward to its minimum spray position.

In use, an artist applies a variety of different paints, e.g., different colors on a given work. At various times, including but not limited to switching to a new paint color, there exists need to flush the nozzle, i.e., blow away paint accumulated near the nozzle. Withdrawing the needle rearward, especially beyond the maximum spray position allowed by the trigger, and concurrently releasing compressed air past the nozzle is a preferred method of flushing the nozzle. Also, the artist may need to remove completely the needle from the airbrush for cleaning or in connection with switching between paints. It is desirable that the airbrush allows a quick and easy release of the needle. Often, the artist wishes to adjust the “preset” minimum spray needle position. In this regard, it is desirable that the airbrush allows convenient adjustment in the airbrush minimum spray or “preset” position.

To minimize distraction from an artistic task at hand, it is desirable that the airbrush support convenient nozzle flushing, needle removal, and adjustment in the minimum spray preset. Embodiments of the present invention provide such an airbrush.

### SUMMARY OF THE INVENTION

An airbrush according to one aspect of the present invention includes a chucking nut coaxial to the airbrush handle and a knob protruding externally from a rearward coaxial opening of the handle. According to another aspect of the present invention, handle adjustment accomplishes preset adjustment. The chucking nut allows quick needle removal, nozzle flushing and adjustment in needle preset.

The subject matter of the present invention is particularly pointed out and distinctly claimed in the concluding portion of this specification. However, both the organization and method of operation of particular embodiments of the present invention, together with further advantages and objects thereof, may best be understood by reference to the following description taken with the accompanying drawings wherein like reference characters refer to like elements.

### BRIEF DESCRIPTION OF THE DRAWINGS

For a better understanding of embodiments of the present invention, and to show how the same may be carried into effect, reference will now be made, by way of example, to the accompanying drawings in which:

FIG. 1 is a side view of an airbrush according to an embodiment of the present invention.

FIG. 2 is a side view similar to FIG. 1 of the airbrush of FIG. 1, but partially cutaway to illustrate internal components thereof.

FIG. 3 is a cross sectional view of a handle portion of the airbrush of FIGS. 1 and 2.

### DETAILED DESCRIPTION OF THE PREFERRED EMBODIMENT

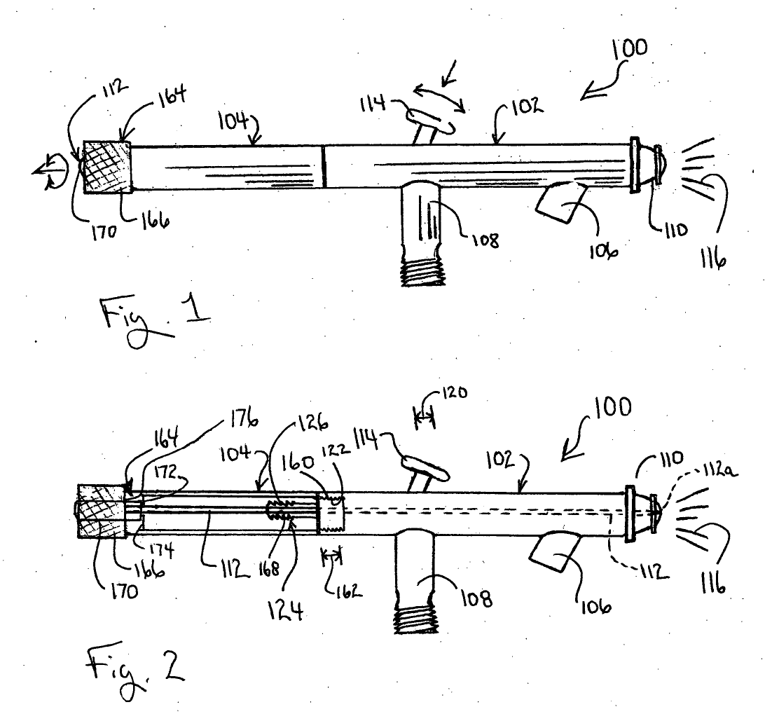

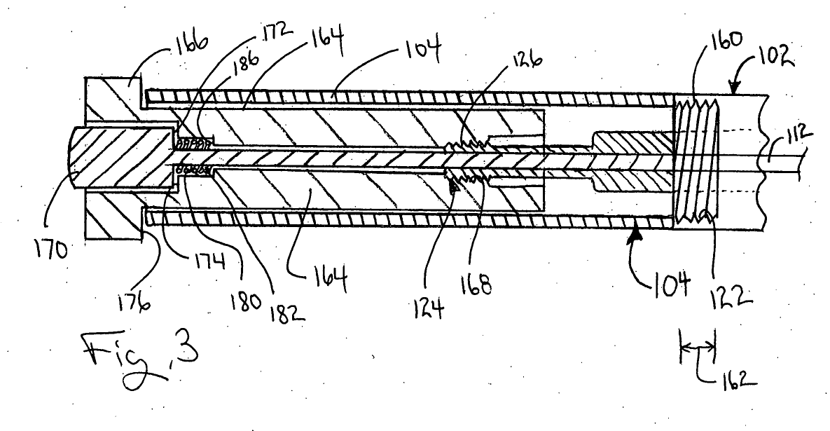

FIG. 1 illustrates an. airbrush 100 according to an embodiment of the present invention. FIG. 2 illustrates airbrush 100 partially broken away to show generally some of the internal components. FIG. 3 details in cross section the components internal to a handle portion of the airbrush 100. In FIGS. 1-3, airbrush 100 includes a body 102 and a handle 104. Body 102 includes a paint inlet 106, a compressed air inlet 108, an outlet nozzle 110, a needle 112, and a trigger 114.

As in conventional use, trigger 114 controls airflow past nozzle 110 and controls longitudinal movement of needle 112 relative to nozzle 110. More particularly, pressing trigger 114 into body 102 releases air past nozzle 110. While a small airflow can be created by slightly pressing trigger 114, generally trigger 114 applies an on-off function relative to airflow, i.e., airflow is either open or closed past nozzle 110.

Rocking trigger 114 forward and rearward moves the tip 112a of needle 112, located within nozzle 110, forward and rearward. The air flows past nozzle 110 and acts to draw material from paint inlet 106 and out nozzle 110. Paint and air thereby intermix as the resulting spray 116. The position of the tip 112a of needle 112 within, i.e., relative to, nozzle 110, as set by trigger 114 position, controls the magnitude of material, e.g., air and paint, in spray 116. The range 120 of needle 112 movement produced by trigger 114 is generally limited to that useful for producing a range of desired spray magnitudes in use of airbrush 100. A minimum spray results with needle 112 at the forward end of range 120 and a maximum spray results with needle 112 at a rearward end of range 120. In some cases, the minimum spray position results in substantially no paint in spray 116, but in other cases the artist may want the minimum spray position to produce spray 116 with some magnitude of paint therein. Also, needle 112 is spring-biased forward, i.e., toward nozzle 110. In other words, airbrush 100 is biased to produce the minimal magnitude spray within the range 120 of spray magnitudes produced by trigger 114. A greater magnitude spray 116 is produced by pulling back on trigger 114.

Thus, an artist manipulates trigger 114 in starting and stopping spray 116, i.e., selectively pressing trigger 114, as well as in concurrently controlling the amount of material in and character of the spray 116, i.e., positioning trigger 114 forward and rearward within range 120.

Handle 104 is a generally tubular structure threadably attachable to body 102. For example male threads 160 at a forward end of handle 160 thread into female threads 122 of body 102. In this regard, and as discussed more fully hereafter, handle 104 can be positioned relative to body 102 within a range 162. With handle 104 fully threaded onto body 102, handle 104 is at a forward end of range 162. With handle 104 partially threaded onto body 102, e.g., enough to reliably hold handle 104 on body 102, handle 104 is at a rearward end of range 162. As described more fully hereafter, the minimum spray position of range 120 can be moved or offset forward and rearward according to range 162. In other words, moving handle 104 forward in range 162 moves the minimum spray position of range 120 forward and moving handle 104 rearward in range 162 moves the minimum spray position of range 120 rearward. As a result, an artist positions handle 104 relative to body 102 to set the minimum spray 116 magnitude for airbrush 100.

A chucking nut 164 positioned coaxially within handle 104 protrudes externally at the rearward end of handle 104. The rearward end of chucking nut 164 offers an external knob 166 available for operation of nut 164 as described more fully hereafter. Chucking nut 164 extends into handle 104 and a forward end thereof threadably attaches to needle chuck 124 of body 102. For example, female threads 168 of chucking nut 164 threadably receive male threads 126 of needle chuck 124. The artist thereby operates chuck 124, i.e., engages and disengages the shaft of needle 112 at chuck 124, by operation of knob 166 without need to dismount handle 104. Thus, rotation of knob 166 loosens and tightens needle chuck 124 relative to the shaft of needle 112 and thereby selectively de-couples and couples, respectively, trigger 114 relative to needle 112. Once de-coupled at chuck 124, needle 112 can be withdrawn rearward from airbrush 100. More particularly, the artist removes needle 112 from body 102 and handle 104 by turning knob 166, thereby releasing needle 112 at chuck 124, and withdrawing needle 112 out the rearward end of chucking nut 164.

The rearward end of needle 112 carries a needle grip 170 resting coaxially within chucking nut 164. Grip 170 includes a forward-facing shoulder 172. Chucking nut 164 includes a rearward-facing shoulder 174. With needle 112 resting coaxially within chucking nut 164 and under normal forward spring-bias, grip 170 of needle 112 can be recessed into chucking nut 164 and, if desired, as far forward as shoulder 174 allows. Pulling knob 166 rearward pulls chuck 124, and therefore needle 112, rearward against the spring-bias of body 102 and beyond the rearward end of range 120. In this manner, an artist pulls the tip 112a of needle 112 well rearward within nozzle 110 and, in conjunction with a release of air past nozzle 110, clears or flushes nozzle 110 of accumulated paint at or near nozzle 110.

Chucking nut 164 includes a second forward-facing shoulder 176 set in relation to handle 104, e.g., positioned to engage the rearward coaxial annular opening of handle 104, to limit forward movement of chucking nut 164 and needle 112 under the influence of the forward spring-bias of body 102. Selectively locating handle 104 within range 162, i.e., by rotation thereof, affects the normally forward biased position of needle 112, i.e., sets the preset minimum spray position for airbrush 100. Fully threading handle 104 into body 102, e.g., where handle 104 is forward of shoulder 176 without engagement therebetween, allows body 102 to pull needle 102 fully forward whereby needle 112 preset is governed by where the artist seats needle 112 in chuck 124. As handle 104 is threaded out of body 102, however, handle 104 engages shoulder 176 and affects needle position by pushing rearward chucking nut 164. Needle 112 follows chuck 124 rearward, as determined by handle 104 position, and needle 112 preset is thereby adjusted.

A rearward cavity 180 in chucking nut 164 and coaxial to needle 112 holds a popout spring 182. When seating needle 112 in airbrush 100, spring 180 compresses between the forward-facing shoulder 172 of needle 112 and the rearward facing shoulder 186 of cavity 180. When the artist rotates knob 166 to release needle chuck 124, spring 182 urges needle grip 170 out the rearward end of chucking nut 164. In this manner the artist easily grasps grip 170 and withdraws needle 112 from airbrush 100.

As may be appreciated, because handle 104 is tubular and need not necessarily include any openings other than at its forward opening, which is closed by body 102 of airbrush 100, and at its rearward opening, which is closed by chucking nut 164, debris and other such material including but not limited to paint, cannot enter handle 104 and undesirably affect operation of, for example, needle chuck 124 or other internal components of airbrush 100.

Thus, an improved airbrush has been shown and described. Airbrush 100 allows convenient needle removal, nozzle flush, and adjustment in the needle preset.

It will be appreciated that the present invention is not restricted to the particular embodiments that have been described and illustrated, and that variations may be made therein without departing from the scope of the invention as found in the appended claims and equivalents thereof.

What is claimed is:

1. An airbrush comprising:
a needle defining a longitudinal axis, the needle having at a forward end a needle tip and at a rearward end a needle grip;
a body having at a forward end a nozzle, the needle tip being located within the nozzle, and at a rearward end a needle chuck;
a tubular handle mountable to the body, the handle being selectively positionable relative to the body and coaxial to the needle when mounted to the body; and
a chucking nut coaxial to the handle and having a knob protruding externally from a rearward opening of the handle, a forward portion of the chucking nut operatively engaging and disengaging the needle chuck in response to operation of the knob.

2. An airbrush according to claim 1, wherein the body normally biases the needle forward toward the nozzle.

3. An airbrush according to claim 2, wherein rearward movement of the knob portion moves the needle rearward.

4. An airbrush according to claim 1, wherein the chucking nut threadably engages the needle chuck and selective rotation of the chucking nut selectively couples and decouples a shaft of the needle relative to the needle chuck.

5. An airbrush according to claim 1, further comprising a popout spring urging the needle grip rearward relative to the chucking nut.

6. An airbrush according to claim 1, wherein a rearward-facing surface of the chucking nut engages a forward-facing surface of the needle.

7. An airbrush according to claim 6, wherein the forward-facing surface of the needle comprises a forward-facing surface of the needle grip.

8. An airbrush according to claim 1, wherein the handle threadably couples to the body whereby selective rotation of the handle establishes a selected position of the handle relative to the body.

9. In an airbrush having a body, the body including a needle, a trigger, a needle chuck, and a nozzle, the trigger selectively moving a tip of the needle through a first range of movement relative to the nozzle, the needle chuck being responsive to the trigger and selectively coupling to and decoupling from a shaft of the needle, an air brush handle comprising:
a tubular sleeve selectively mountable at a forward end thereof to the airbrush and selectively positionable relative to the airbrush through a second range of movement when mounted thereto; and
a chucking nut coaxial to the sleeve, having a forward end operatively coupled to the needle chuck, and having at a rearward end a knob protruding externally of the sleeve, the chucking nut being responsive to the knob to selectively engage and disengage the needle chuck relative to the needle shaft.

10. An airbrush handle according to claim 9, wherein the tubular sleeve threadably mounts to the airbrush whereby selected rotation of the sleeve establishes a selected position of the sleeve relative to the airbrush body.

11. An airbrush handle according to claim 10, wherein the needle is biased in a forward direction.

12. An airbrush handle according to claim 9, wherein the chucking nut threadably engages the needle chuck whereby selective rotation of the knob selectively couples and decouples the needle shaft relative to the needle chuck.

13. An airbrush comprising:
a needle defining a longitudinal axis, the needle having at a forward end a needle tip and at a rearward end a needle grip;
a body having at a forward end a nozzle, the needle tip being located within the nozzle, and at a rearward end a needle chuck;
a tubular handle mountable to the body; and
a chucking nut coaxial to the handle and having a knob protruding externally from a rearward coaxial opening of the handle, a forward portion of the chucking nut operatively engaging and disengaging the needle chuck in response to operation of the knob.

14. An airbrush according to claim 13, wherein the body normally biases the needle forward toward the nozzle.

15. An airbrush according to claim 14, wherein rearward movement of the knob portion moves the needle rearward.

16. An airbrush handle according to claim 13, wherein the chucking nut threadably engages the needle chuck and selective rotation of the chucking nut selectively couples and decouples a shaft of the needle relative to the needle chuck.

17. An airbrush according to claim 13, further comprising a popout spring urging the needle grip rearward relative to the chucking nut.

18. An airbrush according to claim 13, wherein a rearward-facing surface of the chucking nut engages a forward-facing surface of the needle.

19. An airbrush according to claim 18, wherein the forward-facing surface of the needle comprises a forward-facing surface of the needle grip.

20. An airbrush according to claim 13, wherein the handle threadably couples to the body to selectively position the handle relative to the body.
